(19) United States
(12) Patent Application Publication
(10) Pub. No.: US 2026/0228058 A1
(43) Pub. Date: Aug. 6, 2026

(54) APPARATUS FOR IMPLEMENTING DATA-DRIVEN SYNCHRONIZATION IN TASK-PARALLEL AND BARRIER SYNCHRONIZATION IN DATA-PARALLEL PROGRAMS

(71) Applicant: MORPHING MACHINES PVT LTD, Bangalore (IN)

(72) Inventors: Madhava Krishna C, Bangalore (IN); Ranjani Narayan, Bangalore (IN)

(73) Assignee: MORPHING MACHINES PVT LTD, Bangalore, KA (IN)

(21) Appl. No.: 19/149,540

(22) PCT Filed: Jan. 19, 2024
(86) PCT No.: PCT/IN2024/050053

§ 371 Date: Jul. 19, 2025

(30) Foreign Application Priority Data
Jan. 20, 2023 (IN) 202241060128

(51) Int. Cl. G06F 9/52

(52) U.S. Cl. CPC G06F 9/522

(57) ABSTRACT

Disclosed is an apparatus (100) for implementing data-driven synchronization in task-parallel and barrier synchronization in data-parallel programs. The apparatus (100) includes multiple compute elements (CEs) (102-1 to 102-N) for cooperative execution of a program composed of tasks. Tasks are either compute-tasks or service-tasks, with compute tasks executed on the CEs and service tasks used for implementing barrier synchronization in data-parallel programs. Tasks dependency is specified through synchronization instructions. The apparatus (100) also includes an on-chip memory subsystem with private caches of each CE at level-1 (Private L1 cache) (104-1 to 104-N) and a shared cache at level-2 (L2 Shared cache) (108) with software-managed coherence. A synchronization unit (110) maintains a list of records, each associated with a task and its state information. A task dispatcher (112) dispatches compute tasks for execution on CEs based on the record list and implements barrier synchronization using service tasks.

### FIELD OF THE INVENTION

The invention pertains to the field of parallel programming, specifically focusing on an apparatus for implementing data-driven synchronization in task-parallel and barrier synchronization in data-parallel programs for execution by a processing system with software-managed coherence.

### BACKGROUND OF THE INVENTION

In the evolving landscape of high-performance computing, the demand for accelerators capable of efficiently handling both task and data parallel applications has become increasingly pronounced.

Traditional general-purpose multi-core CPUs, while adept at supporting data-level parallelism, face challenges stemming from power and performance inefficiencies due to their complex core design and versatile cache subsystems. The limitations of these CPUs in efficiently supporting data-parallel applications have paved the way for exploring alternative architectures.

General-purpose multi-core CPUs, designed for versatility, have their own complexities that hinder seamless integration and optimal performance in applications heavily reliant on data-parallelism. The intricate architecture introduces inherent bottlenecks, leading to compromised power efficiency and suboptimal performance. As computational demands continue to grow, there is a pressing need for specialized solutions that can overcome the limitations of current architectures.

Beyond task parallelism, traditional CPUs struggle to explore and exploit other forms of parallelism efficiently. The intricacies embedded in their design limit their adaptability to various parallel computing paradigms, particularly in scenarios demanding data-level parallelism. This limitation underscores the necessity for innovative architectures that can address the evolving requirements of diverse parallel computing workloads.

Efforts have been made to address these challenges, with custom-designed many-core accelerators emerging as a promising alternative. Prioritizing efficiency over broad programmability, these accelerators aim to offer specialized solutions. Unlike conventional CPUs, many-core accelerators eschew the overhead of coherent caches, relying instead on data-race-free semantics within application programs and explicit cache flush and invalidation operations to facilitate the shared-memory parallel programming model. This simplified software-based approach to cache coherence achieves significant area and energy savings without sacrificing performance appreciably. Further, these accelerators offer additional benefits in terms of ease-of-verification and scalability.

However, existing software-based cache coherence approaches still grapple with synchronization issues and effective management of both task and data-parallel applications. In the absence of hardware-facilitated cache coherence, many-core accelerators rely on Read-Modify-Write atomic operations directed at the last-level cache (LLC) to implement general synchronization mechanisms. While this approach allows for diverse synchronization primitives (such as locks, barrier, and producer-consumer), its intricate design and reliance on direct LLC manipulation with continuous polling (also known as spin-waiting) can induce significant performance penalties.

As computational workloads grow in complexity, there is therefore a need for a specialized many-core accelerator that is configured for seamlessly integrating data-level and task parallelism while incorporating efficient synchronization mechanisms, such a system should prioritize both power and performance efficiency.

### SUMMARY OF THE INVENTION

In accordance with embodiments, an apparatus is provided for implementing data-driven synchronization in task-parallel and barrier synchronization in data-parallel programs for execution by a processing system with software-managed coherence. The apparatus comprises a plurality of compute elements (CEs) configured for cooperative execution of a program composed of tasks, an on-chip memory subsystem with private caches of each CE at level-1 (L1) and a shared cache at level-2 (L2) with software-managed coherence, a synchronization unit configured to maintain a list of records implemented in hardware, and a task dispatcher configured to dispatch one or more compute tasks for execution on one more CEs of the plurality of CEs based on the record list. The task dispatcher is configured to implement barrier synchronization using service tasks, and to signal one or more CEs to resume execution of stalled compute tasks based on the status of a corresponding service task.

### BRIEF DESCRIPTION OF THE DRAWINGS

The accompanying figures, where like reference numerals refer to identical or functionally similar elements throughout the separate views and which, together with the detailed description below, are incorporated in and form part of the specification, serve to further illustrate various embodiments and to explain various principles and advantages all in accordance with the present invention.

FIG. 1 illustrates the apparatus for implementing data-driven synchronization in task-parallel and barrier synchronization in data-parallel programs for execution by a processing system with software-managed coherence in accordance with one or more embodiments of the invention.

FIG. 2A illustrates an exemplary Task Instance Record Data Structure with its Fields and Layout in accordance with an embodiment of the invention.

FIG. 2B illustrates an exemplary Task Instance Information Data Structure with its Fields and Layout in accordance with an embodiment of the invention.

FIG. 3A illustrates State transition diagram for compute-task in accordance with an embodiment of the invention.

FIG. 3B illustrates State transition diagram for service-task in accordance with an embodiment of the invention.

FIG. 4 illustrates an exemplary execution of Data-Parallel application with N task instance and two barrier synchronizations in accordance with an embodiment of the invention.

FIG. 5 illustrates the parent-child relation between the tasks in accordance with an exemplary embodiment of the invention.

FIG. 6 illustrates data and synchronization dependencies between tasks in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in components related to an apparatus for implementing data-driven synchronization in task-parallel and barrier synchronization in data-parallel programs for execution by a processing system with software-managed coherence. Accordingly, the components and method steps have been represented where appropriate by conventional symbols in the drawings, showing only those specific details that are pertinent to understanding the embodiments of the present invention so as not to obscure the disclosure with details that will be readily apparent to those of ordinary skills in the art having the benefit of the description herein.

The descriptions of the various embodiments of the present invention have been presented for illustration purposes but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

Generally speaking, pursuant to various embodiments, the invention provides an apparatus for implementing data-driven synchronization in task-parallel and barrier synchronization in data-parallel programs for execution by a processing system with software-managed coherence.

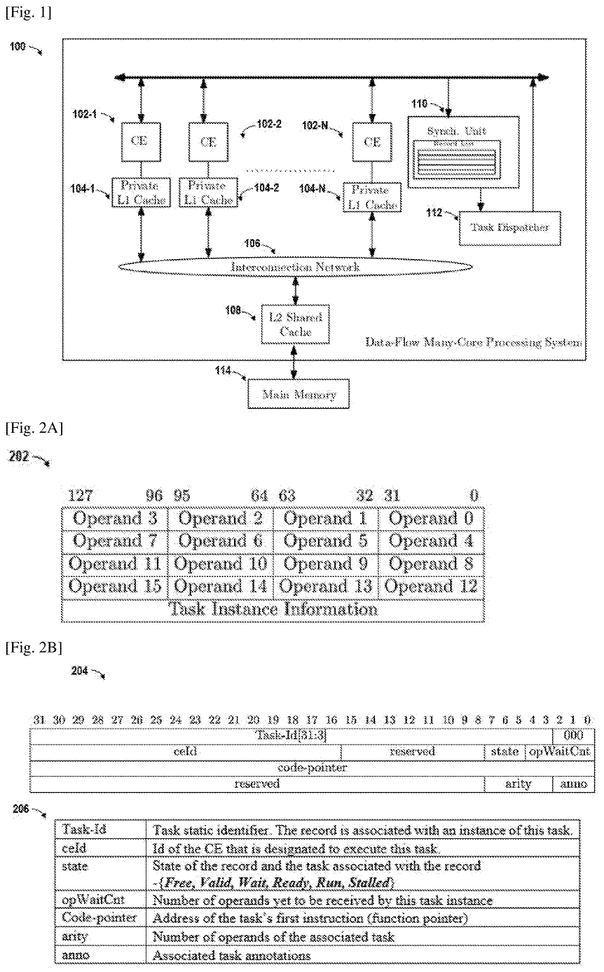

FIG. 1 is a diagram that illustrates an abstract machine model 100 of a dataflow many-core multi-processor in accordance with an embodiment of the invention. Referring to [FIG. 1], the abstract machine model 100 comprises a plurality of Compute Elements (CEs) (102-1 to 102-N) a Private L1 Cache (104-1 to 104-N), an Interconnect Network 106, a L2 shared Cache 108, a synchronization unit 110, a task dispatcher 112 and a Main Memory 114.

As shown in [FIG. 1], the abstract machine model 100 is designed to implement data-driven synchronization in task-parallel and barrier synchronization in data-parallel programs. This is achieved by executing the programs on a processing system with software-managed coherence. The apparatus ensures that tasks are executed in a coordinated manner, thereby enhancing the overall efficiency of the system.

The plurality of CEs (102-1 to 102-N) are configured for cooperative execution of a program composed of tasks.

A task is a macro operation that consumes multiple input operands to produce multiple outputs. These tasks are categorized into two distinct types: compute tasks and service tasks. Compute tasks are designed to perform user defined computational operations and are executed by designated CEs. A service task is a built-in task employed for implementing barrier synchronization in data-parallel programs. The dependencies of these tasks are specified through synchronization instructions, ensuring the program is data-race-free.

A task is a unit of scheduling. A data-flow execution model enforces data-driven scheduling at the level of tasks. And within a compute task, the execution follows the conventional control flow (program-counter driven) scheduling of instructions. Each task is represented by its computation and its static metadata called task-information. A task's computation is encoded as a sequence of instructions (a user-defined function), which are performed in the functional units of CEs.

The constituents of a task-information are as shown below:

$$task - information ∷ = ( code - pointer , arity , annotations )$$

$$annotation ∷ = ( Start , End , Join , Service )$$

Wherein, the code-pointer is the reference to the instruction sequence representing the task computation. The arity specifies the number of operands of the tasks. As an example, the described embodiment of the invention assumes a maximum of 16 operands per task. The annotations (as represented in Table I) give attributes to the tasks.

TABLE I

| | |
|---|---|
| Start | A compute-task that is the entry point of the application. It is |
| | the root node in task dependency graph, that represents the |
| | application program. An application run should involve |
| | only one instance of a Start-task. |
| End | A compute-task is the last task of the application. Application |
| | ends after the execution of the End-task. An application run |
| | should involve only one instance of an End task. |
| Join | A compute-task that implements the join operation as in the |
| | fork-join model. A Join-task can have only 15 operands. The |
| | last operand is reserved, holding the synchronization wait-count, |
| | which is not accessible to the task's computation. |
| Service | A service-task that implements a memory barrier operation. It |
| | is a built-in task (does not have a user-defined function). It is |
| | launched when one or more CEs are in a stall state, and it |
| | resumes only suspended CEs. Each task executing on a CE |
| | that is part of a barrier group must synchronize with the |
| | service-task. It ensures that all memory accesses that precedes |
| | the barrier synchronization are visible to the memory accesses |
| | that follow it. Operand-15, Operand-0 holds the synchronization |
| | wait count that the task must wait for it to become ready. During |
| | the task dispatch, its record is re-initialized for the next instance |
| | of the barrier synchronization, and operand-0 value is used |
| | to set operand-15, the sync-wait-count. |

Apart from the usual arithmetic operations, control operations, and memory load and store operations, a task includes special instructions to communicate, synchronize, and spawn other tasks. At runtime, each instance of a task is associated with a record. Each record holds the operands and instance information of its corresponding task instance. Each task can have at most 16 operands. Outputs produced during the execution of a task may serve as inputs (operands) to other tasks. A producer task directly writes operands to the consumer task's record. The consumer task starts executing as soon as all its operands are available, and its synchronization dependencies are satisfied. The execution of a consumer task may overlap with the execution of its producer tasks.

FIG. 2A illustrates an exemplary Task Instance Record Data Structure with its Fields and Layout in accordance with an embodiment of the invention.

FIG. 2B illustrates an exemplary Task Instance Information Data Structure with its Fields and Layout in accordance with an embodiment of the invention.

Referring to [FIG. 1], the abstract machine model 100, includes an On-chip Memory Subsystem, part of this component, includes the private L1 caches (104-1 to 104-N) associated with a corresponding CE 102-N at level-1 (L1) and a L2 shared cache 108 at level-2 (L2), through the interconnect network 106, with software-managed coherence. The coherence between L1 and L2 caches is ensured through explicit flush and invalidation of L1 cache blocks. This subsystem manages the memory resources effectively, ensuring that the data needed for task execution is readily available, reducing the time taken for data retrieval and thus speeding up the execution of tasks.

The synchronization unit 110 maintains a list of records implemented in hardware. Each record is associated with a task comprising a state information of the task. In an embodiment of the invention, state information corresponding to a task can be, but not limited to, a ready state, a waiting state and a running state.

In an embodiment, a task is configured to create or update records in the list of records using synchronization instructions.

In another embodiment, a compute task being executed on a CE 102-N may add a record corresponding to a new task instance to the list of records. The record is associated with the new task instance based on the task information available as part of the program executable. The state for the new task is set as a wait state, awaiting N synchronization events, wherein N is determined from the task information.

In yet another embodiment, a compute task being executed on a CE 102-N is configured to generate a synchronization event for a task. In response to the synchronization event, the record corresponding to the task is updated in the record list. Further, the record may be updated an input data (or operand) value to the task through the synchronization event.

Compute tasks are also configured to flush the CE's 102-N private L1 cache 104-N in accordance with a memory consistency model before generating the synchronization event, ensuring coherence with the L2 shared cache 108.

The synchronization unit 110 changes the state of a task from a wait state to a ready state upon receiving each of the synchronization events corresponding to the task. Thereafter, the task is forwarded to the task dispatcher 112.

In an embodiment, the task dispatcher 112 is configured to dispatch one or more compute tasks for execution on one more CEs of the plurality of CEs (102-1 to 102-N) based on the record list.

The task dispatcher 112 determine a CE 102-N of the plurality of CEs (102-1 to 102-N) on which a compute task with a ready state is to be executed based on the task information. Accordingly, the task dispatcher 112 configures the determined CE 102-N for the execution of the compute task with ready state.

In an embodiment, the task dispatcher 112 is configured to implement barrier synchronization using service tasks. Barrier synchronization ensures that specific tasks come to a halt at predefined barrier points and cannot progress further until other designated tasks also reach those barrier points. At these synchronization barriers, it is imperative that all tasks maintain a consistent view of the shared memory.

In an embodiment, one or more CEs (102-1 to 102-N) executing one more compute tasks, belonging to a group associated with a barrier, are configured to execute a synchronization instruction. They are configured to generate a synchronization event for the service task and update the record of the service task based on the generated synchronization event. Thereafter, the one or more CEs (102-1 to 102-N) enter a stall state through a suspend instruction following the synchronization instruction.

Moving on, upon receiving the synchronization events, the service task enters into a ready state and the synchronization unit 110 forwards the service task to the task dispatcher 112.

Upon receiving the service task, the task dispatcher 112 is configured to generate signals to the one or more CEs (102-1 to 102-N) executing compute tasks, belonging to the group associated with the barrier, to resume the execution of compute tasks currently being stalled for barrier-synchronization.

In an embodiment, the task dispatcher 112 is further configured to invalidate the private L1 cache 104-N of a CE 102-N in accordance with a memory consistency model. The task dispatcher 112 also ensures that there is coherence between the private L1 cache 104-N and the L2 shared cache 108 before configuring the CE 102-N with a ready task.

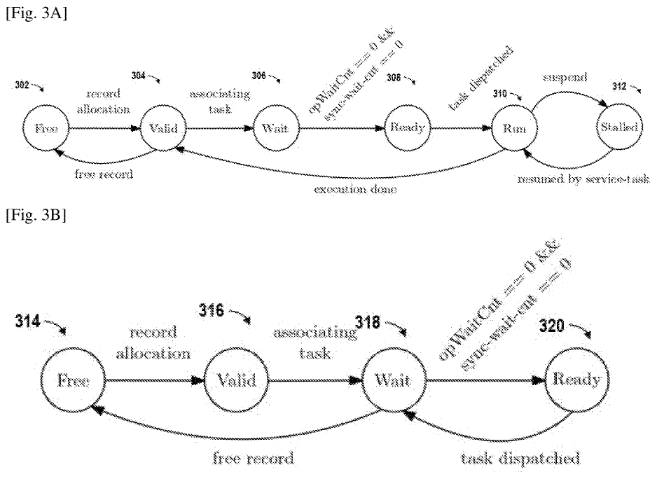

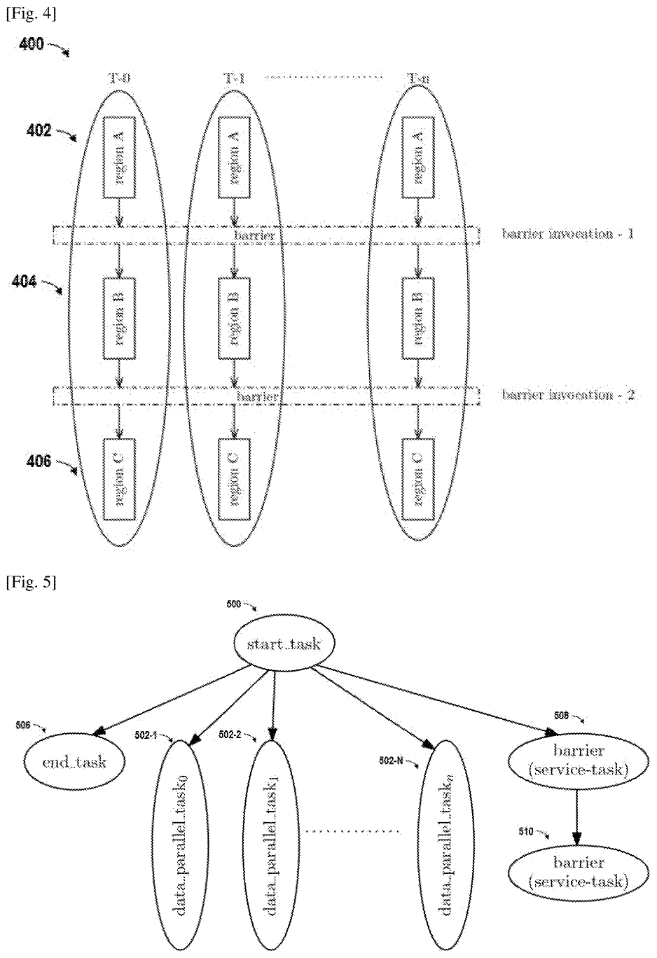

FIG. 3A illustrates State transition diagram for compute-task in accordance with an embodiment of the invention. All records in the synchronization unit 110 starts with a Free state out-of-reset 302. Once a record is allocated it changes to a Valid state 304. While spawning a new task instance, a record with a valid state gets associated with the task instance and changes its state to a Wait state 306. In the wait state 306 the task waits for its operand values and synchronization events, as prescribed by its task information. Note that a record in a wait state 306 knows its task types, as either compute-task or service-task, though the configured task information. The task dispatcher 112 changes the record associated with compute task from a Ready state 308 to a Run state 310, after the task gets dispatched to a CE 102-N Upon executing a suspend instruction, the CE 102-Nstalls itself and sends a message to the synchronization unit 110 that changes the state of the task to a Stalled state 312. The task dispatcher 112 updates the state back to the Run state 310 when a service task signals the corresponding CE to resume its execution.

FIG. 3B illustrates State transition diagram for service-task in accordance with an embodiment of the invention. A Free state 314 and a Valid 316 state remains as in the case of a record associated with a compute task. A service-task does not run on a CE 102-N and is directly executed by the task dispatcher 112. After implementing the barrier synchronization, the task dispatcher 112 changes the service-task state from a Ready state 320 to a Wait state 318 as it prepares for the next instance of the barrier synchronization, by setting the operand-15 the synchronization-wait-count to the same as operand-0 value.

While the specification primarily discusses a single-level task dispatcher for illustrative purposes, it is important to note that the concept extends seamlessly to hierarchical configurations. In a hierarchical setup, multiple layers or levels of task dispatchers may be employed, each corresponding to a specific layer or level within the system architecture. The absence of explicit mention of hierarchical task dispatchers in the specification should not be construed as a limitation on the scope of the invention.

FIG. 4 illustrates an exemplary execution of a Data-Parallel application with N task instance and two barrier synchronizations in accordance with an embodiment of the invention.

Referring to [FIG. 4], the diagram illustrates barrier synchronization in a data-parallel application 400 with N task instances (T0 . . . TN) running on CEs (102-1 to 102-N). Each task computation is segmented into three regions: region A (402), region B (404), and region C (406), with adjacent regions connected by a barrier.

The barrier synchronizer ensures that in a given task, region B (404) must take into account all memory accesses made in region A (406) by all other tasks. Similarly, in the same task, region C (406) must observe all memory accesses performed in region B (404) by all other tasks.

As explained earlier, the disclosed data-flow many-core accelerator executes the data-parallel application 400 by running each task on a CE 102-N. Each CE accesses the shared memory through its private L1 cache 104-N. The private L1 cache 104-N caches the entire shared memory address space. Each task running on the CE 102-N updates the L2 shared Cache 108 in its private L1 cache 104-N. In the data-parallel application 400, barrier synchronization requires that each task sees the shared memory updates performed by all other tasks in their respective CE's private L1 caches (104-1 to 104-N).

The proposed system depends on software-managed cache coherence, employing a mechanism where each private L1 cache 104-N undergoes explicit flushing. This involves transferring dirty data from the private L1 cache 104-N to the L2 shared cache 108, thereby changing its state from dirty to clean. Additionally, the caches are invalidated, removing outdated data copies in the private L1 cache 104-N by changing their state from clean to invalid, all of which occurs during barrier synchronization.

In accordance with the embodiments of the invention, as part of the software-managed cache coherence, each task is configured to execute a private L1 104-N cache flush at the conclusion of computations in both region A (402) and region B (404) if these regions modify the shared memory through store instructions. This flush operation ensures coherence between the private L1 cache 104-N and the shared L2 cache 108. To propagate these updates to other tasks, the respective CEs' private L1 caches (104-1 to 104-N) must be invalidated. This guarantees that subsequent load operations, following the barrier-synchronization, retrieve the most recent values available in the L2 shared cache 108.

To optimize performance and prevent unnecessary flushes and invalidations, a private L1 cache flush is only performed if the task executes stores to the L2 shared cache 108. Likewise, a private L1 cache invalidation occurs only if other task instances involved in the barrier have executed stores. The efficiency of these flush and invalidation processes is maintained based on a memory-consistency model agreed upon by the software and the system hardware.

In accordance with the embodiments of the invention, flushes are performed as part of task functionality, as each task is aware of its store operations performed before barrier synchronization. Since invalidation requires a global view (store performed by other tasks), it is dictated by the task dispatcher 112. Each task notifies the task dispatcher 112 about its updates to shared memory through the synchronization unit 110, which helps the task dispatcher 112 to invoke the private L1 cache invalidations efficiently.

This coordinated approach ensures synchronization and coherence across tasks, allowing for optimized cache management during the barrier synchronization process.

Below is the pseudo-code that describes the data-parallel application 400 explained in conjunction with [FIG. 4].

| | |
|---|---|
| 1. | Record barrier; /* service-task */ |
| 2. | Record data_parallel_task[N]; /* compute-task */ |
| 3. | Record end_task; /* compute-task */ |
| 4. | void data_parallel_task_func( int offset0, int offset1, int offset2); |
| 5. | void end_task_func( ); |
| 6. | TaskInfo data_parallel_task_info = {.arity=3, .code-pointer= |
| | data_paralel_task_func}; |
| 7. | TaskInfo barrier_info = {.arity=2, .anno=SERVICE}; |
| 8. | TaskInfo end_task_info = {.arity=1, .anno=(END \| JOIN), |
| | .code-pointer = end_task_func}; |
| 9. | void start_task( ) { |
| 10. | task_spawn(barrier, barrier_info); |
| 11. | sync_data(barrier, 0, N); |
| 12. | sync_data(barrier, 15, N); |
| 13. | task_spawn(end_task, end_task_info); |
| 14. | sync_data(end_task, 15, N); |
| 15. | for(int i = 0; i < N; i++) { |
| 16. | task_spawn(dpTask[i], data_parallel_task_info); |
| 17. | } |
| 18 | /* send the required input data to data_parallel_task instances using |
| | sync_data. */ |
| 19. | } |
| 20. | void data_parallel_task_func( int dim0, int dim1, int dim2 ) { |
| 21. | regionA( ... ); |
| 22. | /* first barrier invocation */ |
| 23. | sync(barrier, −1); |
| 24. | suspend( ); |
| 25. | regionB( ...... ); |
| 26. | /* second barrier invocation */ |
| 27. | sync(barrier, −1); |
| 28. | suspend( ); |
| 29. | regionC( ..... ); |
| 30. | sync(end_task, −1); |
| 31. | } |
| 32. | void end_task_func( ) { |
| 33. | ........ |
| 34. | } |

The data-parallel application 400 includes four distinct tasks: start_task, data_parallel_task, end_task and barrier. The first three are compute-tasks, while the fourth is a service-task.

Note that the barrier task's information in line-9 defines its annotation as SERVICE. The start_task is invoked externally during runtime initialization, with no specific task information defined. The end_task serves as the concluding task annotated with END (line-10).

The start_task spawns N instances of data_parallel_task (line-21), along with instances of end_task (line-17) and barrier (line-13).

FIG. 5 illustrates the parent-child relation between the tasks in accordance with an exemplary embodiment of the invention. Note that all the records required for task instances are statically allocated in this example, as shown in lines 1-3. Referring to [FIG. 5], a Start_task 500 spawns N instances of data_parallel_task (502-1 . . . 502N), an instance of end_task 506, and an instance of barrier 508. The barrier (service task) 508, upon execution by the task dispatcher 112, spawns another barrier 510 to prepare for the next barrier-synchronizer (the barrier between region B 404 and region C 406).

Spawning a task associates a record entry in the synchronization unit 110 with the newly spawned task information. For instance, for data_parallel_task, the associated record transitions from Valid to Wait, setting the operand wait count as per the task information's arity field. This dictates to the synchronization unit 110 that an instance of data_parallel_task is created and is waiting for three operand values.

The sync_data statement in the start_task_func definition, generates messages to the synchronization unit 110 to update the corresponding records with the provided operand.

For instance, the execution of sync_data (end_task, 15, N) at line-18 triggers the generation of a message to the synchronization unit 110, instructing it to update the operand-15 field of the end_task record with the value N. Simultaneously, it decrements the operand-wait-count by 1. It's noteworthy that end_task is marked as JOIN (line-10) compute-task, signifying that the operand-15 of end_task serves as the synchronization wait count. A task achieves readiness once both its operand wait count and synchronization wait count reach zero.

In this context, end_task must await N synchronization events to attain readiness. Additionally, each data_parallel_task induces a synchronization event for end_task by executing sync (end_task, −1) at line-43.

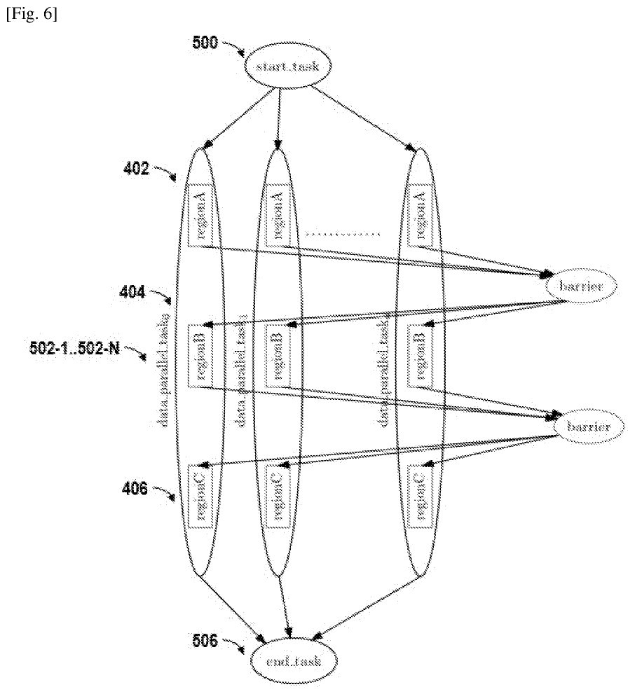

FIG. 6 illustrates data and synchronization dependencies between tasks of the data-parallel application 400 in accordance with an embodiment of the invention. Referring to [FIG. 6], Each edge denotes one or more data or synchronization dependencies between the connected nodes.

Line-13 spawns the service-task by associating barrier record with the barrier_info task information. Lines 14-15 update the barrier record's operand-0 and operand-15 fields with the value ‘N’. Upon each synchronization event reception, this field undergoes a decrement of 1. For the first barrier synchronization, this count is set explicitly by the user code. Subsequently, for all successive invocations of the barrier synchronizer, the task dispatcher 112 autonomously configures operand-15 based on the operand-0 value defined in Line-14.

Lines 27-44, define data_parallel_func, the compute-task's user-defined function. The arity of data_parallel_task is set to 3, reflecting the function's three parameters. Lines 32-33 and Lines 38-39 define the first and second barrier invocations, respectively. Barrier is defined as a synchronization instruction (Lines 32 and 38) followed by a suspend instruction (Lines 33 and 39).

The proposed many-core accelerator introduces a paradigm shift by eliminating spin waiting in synchronization mechanisms. This approach disclosed here significantly enhances bandwidth utilization by eradicating unnecessary and resource-intensive memory accesses associated with traditional spin-waiting techniques. As a result, the apparatus achieves a more efficient and streamlined execution of both task and data-parallel programs, contributing to an overall improvement in performance.

By mitigating spin waiting and introducing a dynamic synchronization model, the many-core accelerator effectively reduces resource contention within the system. This reduction in contention improves communication latencies, leading to a notable performance improvement. Tasks can seamlessly progress through their execution phases without unnecessary delays, optimizing the overall system throughput.

The synchronization approach employed in the many-core accelerator translates into a simplified cache design. Unlike conventional methods that necessitate support for atomic Read-Modify-Write (RMW) operations, the proposed system avoids this complexity. By doing so, the architecture streamlines cache management, resulting in a more straightforward and efficient design that meets the demands of task and data-parallel programs without compromising on performance.

These advancements collectively contribute to a more efficient and high-performing many-core accelerator tailored to meet the demands of modern parallel computing applications.

1. An apparatus (100) for implementing data-driven synchronization in task-parallel and barrier synchronization in data-parallel programs for execution by a processing system with software-managed coherence, comprising:
a plurality of compute elements (CEs) (102-1 to 102-N) configured for cooperative execution of a program composed of tasks, wherein a task is one of a compute-task and service-task, wherein compute tasks are exclusively executed on the plurality of CEs (102-1 to 102-N), and service tasks are employed for implementing barrier synchronization in data-parallel programs, wherein tasks dependency is specified through synchronization instructions;
On-chip memory subsystem with private caches of each CE at level-1 (Private L1 Cache) (104-1 to 104-N) and a shared cache at level-2 (L2 Shared Cache) (108) with software-managed coherence, where coherence between Private L1 Cache (104-1 to 104-N) and L2 Shared cache (108) is ensured through explicit flush and invalidation of L1 cache blocks;
a synchronization unit (110) configured to maintain a list of records implemented in hardware, wherein each record is associated with a task comprising a state information of the task, wherein a state information includes one of a ready state, a waiting state and a running state, wherein a task is configured to create or update records in the list of records using the synchronization instructions; and
a task dispatcher (112) configured to dispatch one or more compute tasks for execution on one more CEs of the plurality of CEs (102-1 to 102-N) based on the record list, wherein the task dispatcher 112 is configured to implement barrier synchronization using service tasks, wherein the task dispatcher 112 is configured to signal one or more CEs to resume execution of stalled compute tasks based on the status of a corresponding service tasks, wherein the plurality of CEs (102-1 to 102-N), the on-chip memory subsystem, the synchronization unit 108, and the task dispatcher 112 are communicatively coupled to each other.

2. The apparatus of claim 1, wherein a record is added corresponding to a new task instance to the list of records by a compute-task being executed on a CE, wherein the record is associated with the new task instance based on the task information available as part of the program executable and the corresponding state is set to a wait state, awaiting N synchronization events, wherein N is determined from the task information.

3. The apparatus of claim 1, wherein a compute task being executed on a CE is configured to:
generate a synchronization event for a task;
update the record for the task based on the synchronization event;
update a record with an input data value to the task through the synchronization event; and
flush the CE's Private L1 cache in accordance with a memory consistency model before generating the synchronization event, ensuring coherence with the shared L2 cache 108.

4. The apparatus of claim 1, wherein a service task is a system-level task, devoid of user-defined computation, tasked with enforcing memory barrier synchronization.

5. The apparatus of claim 1, wherein the synchronization unit (110) is configured to:
change the state of a task from a wait state to a ready state upon receiving each of the synchronization events corresponding to the task; and
forward the task to the task dispatcher.

6. The apparatus of claim 5, wherein the task dispatcher (112) is configured to:
determine a CE of the plurality of CEs (102-1 to 102-N) on which a compute task with a ready state is to be executed based on the task information; and
configure the determined CE for the execution of the compute task with ready state.

7. The apparatus of claim 6, wherein one or more CEs, executing one more compute tasks, belonging to a group associated with a barrier are configured to:
execute a synchronization instruction;
generate a synchronization event for the service task;
update the record of the service task based on the generated synchronization event; and
enter into a stall state through a suspend instruction following the synchronization instruction.

8. The apparatus of claim 7, wherein upon receiving the synchronization events, the service task enters into a ready state and the synchronization unit (110) forwards the service task to the task dispatcher.

9. The apparatus of claim 8, wherein the task dispatcher (112) is configured to:
upon receiving the service task, generate signals to the one or more CEs of the plurality of CEs (102-1 to 102-N) executing compute tasks, belonging to the group associated with the barrier, to resume the execution of compute tasks currently being stalled for barrier-synchronization.
Update the record of service task with the synchronization-wait-count and changes its state from ready state to waiting state (for the next invocation of barrier synchronization).

10. The apparatus of claim 9, wherein the task dispatcher (112) is further configured to:
invalidate the private L1 cache (104-N) of a CE (102-N) in accordance with a memory consistency model; and
ensuring coherence between the private L1 cache (104-N) and the L2 shared cache (108) before configuring the CE (102-N) with a ready task.
